(19) United States
(12) Patent Application Publication
(10) Pub. No.: US 2011/0128125 A1
(43) Pub. Date: Jun. 2, 2011

(54) ANTENNA DEVICE AND SYSTEM INCLUDING ANTENNA DEVICE

(75) Inventors: Manabu Kai, Kawasaki (JP); Teruhisa Ninomiya, Kawasaki (JP)

(73) Assignee: FUJITSU LIMITED, Kawasaki-shi (JP)

(21) Appl. No.: 12/905,528

(22) Filed: Oct. 15, 2010

(30) Foreign Application Priority Data
Nov. 27, 2009 (JP) 2009-269850

(51) Int. Cl. H04Q 5/22

(52) U.S. Cl. 340/10.1

(57) ABSTRACT

An antenna device performs communications with an identification tag by being connected to a reading device that reads identification information of the identification tag. The antenna device includes a first power feeding unit configured to receive power from the reading device; a resonator that is electromagnetically coupled to the first power feeding unit, the resonator having a predetermined bandwidth including a working frequency of the reading device; and a second power feeding unit that is electromagnetically coupled to the resonator, the second power feeding unit being terminated according to a predetermined resistance value.

### CROSS-REFERENCE TO RELATED APPLICATIONS

This patent application is based upon and claims the benefit of priority of the prior Japanese Patent Application No. 2009-269850 filed on Nov. 27, 2009, the entire contents of which are incorporated herein by reference.

### FIELD

The embodiments discussed herein are related to an antenna device and a system including an antenna device.

### BACKGROUND

Conventionally, systems using identification tags such as RFID (Radio Frequency Identification) tags are used for managing various articles.

An RFID tag includes an IC (Integrated Circuit) chip storing identification information. When the RFID tag receives reading signals of the RF (Radio Frequency) band from the reader/writer, the IC chip is activated by the power of the received signals. Then, the RFID tag returns identification information to the reader/writer. In this manner, the reader/writer reads identification information from the RFID tag.

There are two types of RFID tags. One type is an active type with a built-in power source. The other type is a passive type without a power source; the passive type operates by using an electric field or a magnetic field supplied from outside as a power source. As the passive type does not include a power source, the passive type is inappropriate for long distance communications. However, the passive type is advantageous in terms of being compact and low-price.

The frequency of the RFID tag used for wireless communications is defined in each country. For example, in the UHF (Ultra High Frequency) band, the frequency in Japan is typically 952 MHz through 954 MHz or 2.45 GHz. Furthermore, the frequencies typically allocated in the United States and in Europe are 915 MHz and 868 MHz, respectively.

For example, the communications distance is approximately 3 m through 5 m, when communications are performed between a patch antenna device and a passive type RFID tag that uses a frequency of 953 MHz in the UHF band, although this depends on the type of the antenna device connected to the reader/writer and the minimum operation power of the IC chip used in the RFID tag.

A patch antenna device is an example of the antenna device used for a reader/writer that performs communications with RFID tags. However, expensive copper foil is used in the patch conductor of the patch antenna device, and therefore the manufacturing cost is high.

There are systems for managing articles with the use of RFID tags without requiring a communication distance as long as 3 m through 5 m. For example, such systems manage the presence of articles within a communication range as short as approximately 10 cm or less.

For example, there is a system for managing the presence of articles by placing the articles with RFID tags on an antenna device. In this case, the antenna device needs to be suited for short-range communications in order to manage whether the articles have been removed from the antenna device.

The following are descriptions of antenna devices suited for short-range communications. Specifically, one example of such an antenna device includes a continuous transmission line located between a power feeding unit and a terminating resistor, and a branch line that branches from the transmission line. An electromagnetic field or a magnetic field is generated only near the transmission line or the branch line so that the communication range of the antenna device is reduced.

Another example of an antenna device for short-range communications does not include a branch line but includes a transmission line that is formed in a meandering shape.

Antenna devices for short-range communications do not include expensive patch conductors, and therefore manufacturing costs are significantly reduced.

Patent Document 1: Japanese Laid-Open Patent Application No. 2007-306438

Patent Document 2: Japanese Laid-Open Patent Application No. 2008-519571

In conventional antenna devices for short-range communications, the power feeding unit and the terminating resistor are connected by a transmission line. Therefore, the transmission loss is large, and the power needed for communicating with RFID tags may not be sufficiently acquired.

Accordingly, there may be cases where it is not possible to perform communications with RFID tags or to read the identification information, even in areas directly above the antenna device. This problem particularly tends to occur in areas near the terminating resistor.

Furthermore, when the number of branch lines of an antenna device is increased in an attempt to increase areas for communicating with RFID tags, the transmission line also needs to be extended. In this case, the transmission loss is further increased, and the power may decrease near the terminating resistor. For this reason, even if the number of branch lines of an antenna device is increased, it may not be possible to increase the areas for communicating with RFID tags.

Similarly, in an antenna device with a transmission line having a meandering shape, the transmission loss increases. Therefore, in this case also, identification information of RFID tags may not be read even in areas directly above the antenna device. The number of bending portions of the meandering shape may be increased in an attempt to reduce areas of the antenna device that cannot be used for reading identification information. However, by increasing the number of such bending portions, the length of the transmission line is consequently increased. For this reason, even if the number of bending portions of the meandering shape is increased, it may not be possible to increase the areas for communicating with RFID tags.

### SUMMARY

According to an aspect of the invention, an antenna device performs communications with an identification tag by being connected to a reading device that reads identification information of the identification tag; the antenna device includes a first power feeding unit configured to receive power from the reading device; a resonator that is electromagnetically coupled to the first power feeding unit, the resonator having a predetermined bandwidth including a working frequency of the reading device; and a second power feeding unit that is electromagnetically coupled to the resonator, the second power feeding unit being terminated according to a predetermined resistance value.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIGS. 1A through 1C illustrate an antenna device according to a first embodiment of the present invention, where FIG. 1A is a plan view, FIG. 1B is cross-sectional view cut along a line A-A′ of FIG. 1A, and FIG. 1C is a bottom view;

FIGS. 2A and 2B illustrate an RFID tag for communicating with the antenna device according to the first embodiment of the present invention, where FIG. 2A is a plan view and FIG. 2B illustrates an equivalent circuit;

FIG. 3 illustrates a reader/writer connected to the antenna device according to the first embodiment of the present invention;

FIGS. 4A and 4B illustrate simulation results indicating frequency properties of power generated at the RFID tag placed on a resonator of the antenna device according to the first embodiment of the present invention;

FIG. 5A illustrates the reader/writer connected to an antenna device according to a comparison example;

FIG. 5B illustrates simulation results indicating frequency properties of power generated at the RFID tag placed on the antenna device illustrated in FIG. 5A;

FIG. 6A is a plan view of an antenna device according to a second embodiment of the present invention;

FIG. 6B illustrates the antenna device illustrated in FIG. 6A connected to the reader/writer;

FIG. 7 is a perspective view of an antenna device according to a third embodiment of the present invention;

FIGS. 8A and 8B illustrate an antenna device according to a fourth embodiment of the present invention, where FIG. 8A is a plan view and FIG. 8B is a bottom view;

FIG. 9 is a perspective view of an antenna device according to a fifth embodiment of the present invention;

FIG. 10 illustrates a system according to a sixth embodiment of the present invention including an antenna device;

FIG. 11 is a table indicating the relationship between identification ID and article data used in the system according to the sixth embodiment including an antenna device;

FIG. 12 is a flowchart of an article management process performed by the system according to the sixth embodiment of the present invention including an antenna device; and

FIG. 13 is a perspective view of articles placed on an antenna device in the system according to the sixth embodiment including an antenna device.

### DESCRIPTION OF EMBODIMENTS

An antenna device and a system including an antenna device according to embodiments of the present invention will be explained with reference to accompanying drawings.

### First Embodiment

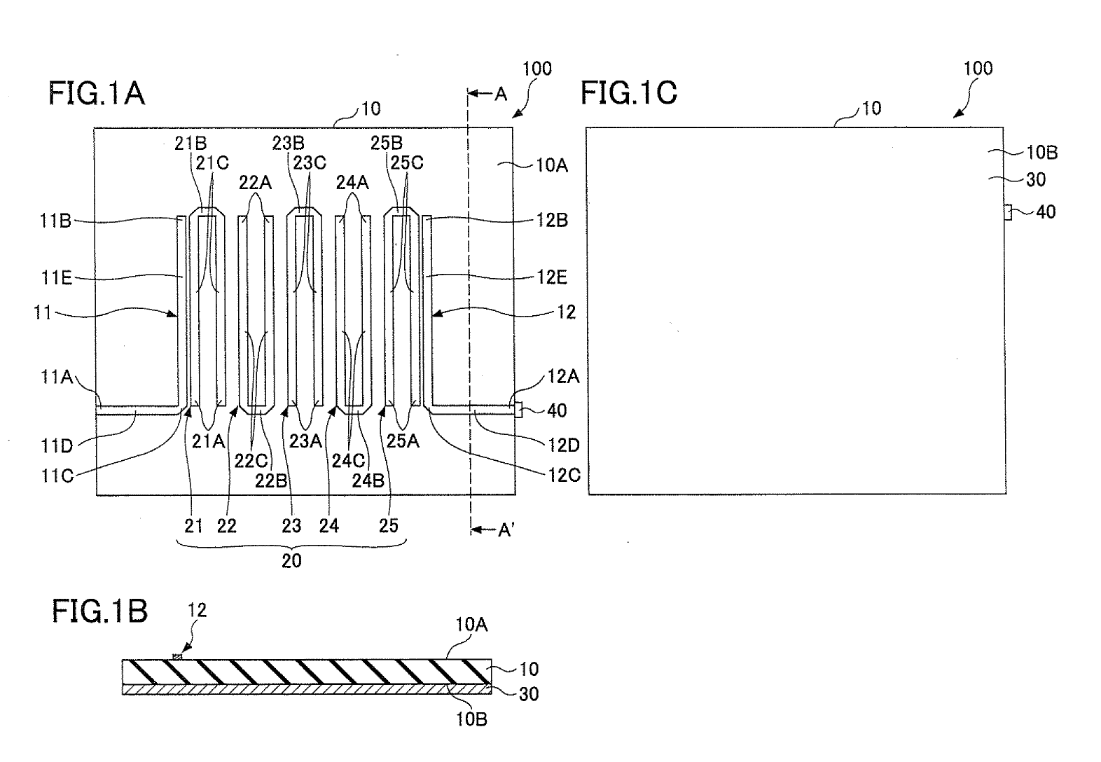

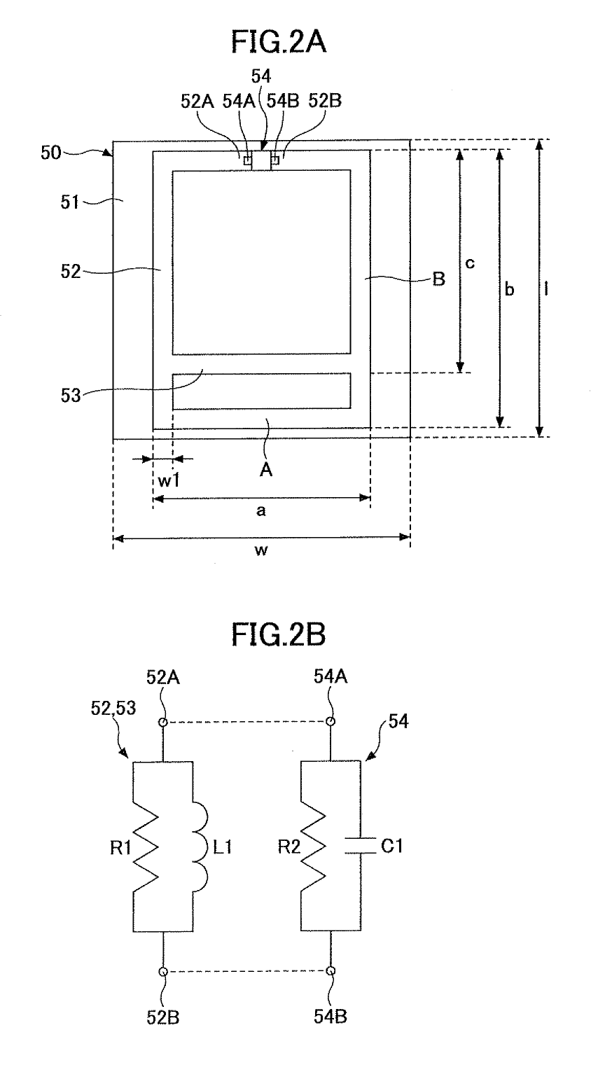

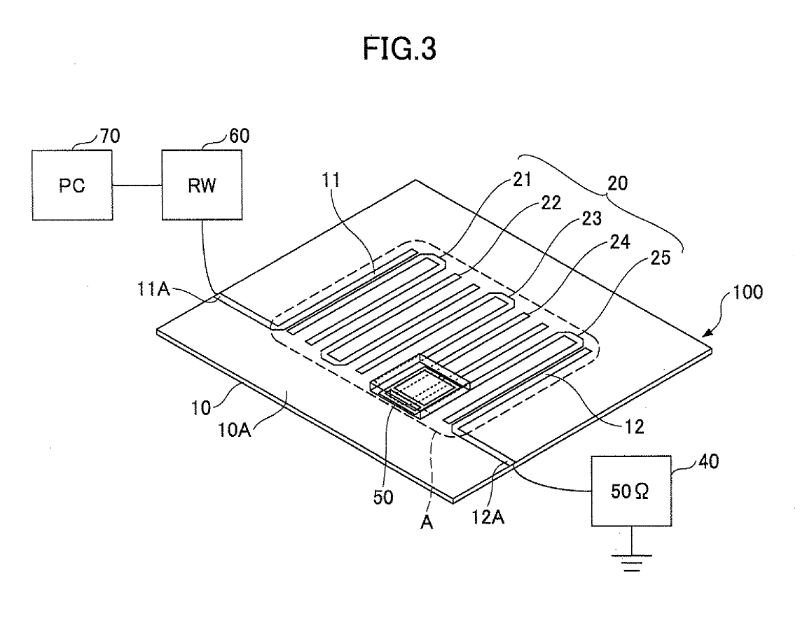

FIGS. 1A through 1C illustrate an antenna device according to a first embodiment of the present invention. FIG. 1A is a plan view, FIG. 1B is cross-sectional view cut along a line A-A′ of FIG. 1A, and FIG. 1C is a bottom view. An antenna device 100 according to the first embodiment is connected to a reader/writer for reading identification information of RFID tags, and performs communications with nearby RFID tags. First, a description is given of the antenna device 100 with reference to FIGS. 1A through 1C, and then the RFID tags and the reader/writer are described with reference to FIGS. 2A through 3.

The antenna device 100 according to the first embodiment includes a printed-circuit board 10, power feeding lines 11 and 12 that are formed on a front surface 10A of the printed-circuit board 10, a resonator 20, and a ground plane 30 formed on a back surface 10B of the printed-circuit board 10.

For example, the printed-circuit board 10 is FR-4 (Flame Retardant Type 4; glass cloth base material epoxy resin substrate) having a dielectric constant of εr=4.4 and a dielectric tangent of tan δ=0.002. On the front surface 10A of the printed-circuit board 10, copper foil is provided for forming the power feeding lines 11 and 12 and the resonator 20. Furthermore, copper foil is provided for forming the ground plane 30 on the entire back surface 10B (see FIGS. 1B and 1C). For example, the printed-circuit board 10 has a length (a length in the vertical direction as viewed in FIG. 1A) of 80 mm, a width (a width in the horizontal direction as viewed in FIG. 1A) of 80 mm, and a thickness of 1 mm.

For example, the power feeding lines 11 and 12 and the resonator 20 are formed by patterning the copper foil applied on the entire front surface 10A of the printed-circuit board 10, and performing an etching process with the use of resist.

In the first embodiment, micro-strip lines having the same width are used as the power feeding lines 11 and 12 and the resonator 20. For example, the thickness of the micro-strip line is 0.03 mm, which is the same as the thickness of the ground plane 30 formed on the back surface 10B of the printed-circuit board 10.

For example, in the first embodiment, the power feeding lines 11 and 12 and the resonator 20 are formed so as to be exposed on the front surface 10A of the printed-circuit board 10.

The power feeding line 11 is a first power feeding unit having a reversed L shape formed by bending a micro-strip line having free ends into a right angle with respect to the longitudinal direction as viewed from the top. The power feeding line 11 includes an end part 11A, an end part 11B, a bent part 11C, a linear part 11D, and a linear part 11E. The linear part 11D extends between the end part 11A and the bent part 11C. The linear part 11E extends between the bent part 11C and the end part 11B. In the first embodiment, the reader/writer for reading the RFID tags is connected to the end part 11A, and power is fed to the power feeding line 11 via the end part 11A.

The power feeding line 11 is formed on the front surface 10A such that impedance matching is achieved between the power feeding line 11 and a resonance element 21 of the resonator 20. Specifically, the space between the linear part 11E and the resonance element 21, the width and thickness of the micro-strip line, and the length of the linear part 11E are appropriately adjusted. Accordingly, electromagnetic field coupling is achieved between the power feeding line 11 and the resonance element 21 in a state where the impedance is also matched.

The above configuration is for achieving a substantially nonreflective state between the power feeding line 11 and the resonance element 21 so that the power loss is substantially zero when supplying power from the power feeding line 11 to the resonance element 21.

The power feeding line 12 is a second power feeding unit having an L shape formed by bending a micro-strip line having free ends into a right angle with respect to the longitudinal direction as viewed from the top. The power feeding line 12 includes an end part 12A, an end part 12B, a bent part 12C, a linear part 12D, and a linear part 12E. The linear part 12D extends between the end part 12A and the bent part 12C. The linear part 12E extends between the bent part 12C and the end part 12B. In the first embodiment, a terminating resistor 40 is connected to the end part 12A.

The power feeding line 12 is formed on the front surface 10A such that impedance matching is achieved between the power feeding line 12 and a resonance element 25 of the resonator 20. Specifically, the space between the linear part 12E and the resonance element 25, the width and thickness of the micro-strip line, and the length of the linear part 12E are appropriately adjusted. Accordingly, electromagnetic field coupling is achieved between the power feeding line 12 and the resonance element 25 in a state where the impedance is also matched.

The above configuration is for achieving a substantially nonreflective state between the power feeding line 12 and the resonance element 25 so that the power loss is substantially zero when supplying power from the power feeding line 12 to the resonance element 25.

The impedance of the terminating resistor 40 is to match the input impedance of the power feeding line 12, the resonator 20, and the power feeding line 11 as viewed from the end part 12A in a state where the terminating resistor 40 is removed. The antenna device 100 according to the first embodiment of the present invention has an input impedance of 50 Ω, and therefore the impedance of the terminating resistor 40 is to be specified as 50 Ω. Accordingly, the end part 12A of the power feeding line 12 is terminated with a predetermined resistance value.

As illustrated in FIG. 1A, the antenna device 100 according to the first embodiment is bilaterally symmetric, and therefore the power feeding line 11 and the power feeding line 12 may be interchanged. That is to say, the terminating resistor 40 may be connected to the end part 11A and the reader/writer may be connected to the end part 12A.

The resonator 20 includes resonance elements 21, 22, 23, 24, and 25. The resonance elements 21 through 25 are lines in which electromagnetic waves resonate in a predetermined frequency band. Electromagnetic waves of a predetermined frequency band pass through the resonator 20 according to electromagnetic field coupling among the resonance elements 21 through 25. The resonance elements 21 through 25 have the same shape. Each of the resonance elements 21 through 25 has a hairpin shape in a planar view, in which a micro-strip line having free ends is bent at the center point in the longitudinal direction. The length of the resonance elements 21 through 25 is specified to be substantially the half wavelength (λ/2) of a wavelength λ in the working frequency of the resonance elements 21 through 25. As described above, in the first embodiment, the resonance elements 21 through 25 have hairpin shapes, and therefore the antenna device 100 is made compact.

The working frequency corresponds to the carrier wave in the RF band output by the reader/writer described below. In the example described in the first embodiment, the working frequency is 953 MHz.

The resonance elements 21 through 25 are formed on the front surface 10A of the printed-circuit board 10 such that the top surfaces are exposed. The length of the resonance elements 21 through 25 is determined in consideration of the thickness of the printed-circuit board 10, the dielectric constant (εr=4.4) of the printed-circuit board 10, and the dielectric constant of air (εs=1.00058).

For example, the half wavelength (λ/2) in the resonance elements 21 through 25 is specified as approximately 92.8 mm. The length of the resonance elements 21 through 25 may be derived by an electromagnetic field simulator.

The resonance element 21 includes an open end 21A, a short-circuited end 21B, and a pair of linear parts 21C. Similarly, the resonance elements 22 through 25 include open ends 22A through 25A, short-circuited ends 22B through 25B, and pairs of linear parts 22C through 25C, respectively.

The resonance elements 21 through 25 are equidistantly arranged parallel to each other, such that the positions of the pairs of linear parts 21C through 25C are aligned in the lengthwise direction.

A description is given of the space between the two linear parts, by taking as an example the resonance element 21. Specifically, the space between the linear parts 21C may be set to be two times the width of the micro-strip line forming the resonance element 21.

As illustrated in FIG. 1A, in the resonance element 21, one of the linear parts 21C (the linear part 21C on the left side as viewed in FIG. 1A) is parallel to the linear part 11E of the power feeding line 11 having a reversed L shape.

The resonance element 21 is formed on the front surface 10A such that impedance matching is achieved between the resonance element 21 and the power feeding line 11. Specifically, the space between the linear part 11E and the linear part 21C on the left side as viewed in FIG. 1A is appropriately adjusted. Accordingly, electromagnetic field coupling is achieved between the resonance element 21 and the power feeding line 11 in a state where the impedance is also matched.

The resonance elements 21 through 25 are positioned in such a manner that the open ends 21A through 25A and the short-circuited ends 21B through 25B are alternately arranged.

The resonance element 22 is formed such that the open end 22A is positioned near the short-circuited end 21B of the resonance element 21 and the short-circuited end 22B is positioned near the open end 21A of the resonance element 21.

The resonance element 23 is formed such that the open end 23A is positioned near the short-circuited end 22B of the resonance element 22 and the short-circuited end 23B is positioned near the open end 22A of the resonance element 22.

The resonance element 24 is formed such that the open end 24A is positioned near the short-circuited end 23B of the resonance element 23 and the short-circuited end 24B is positioned near the open end 23A of the resonance element 23.

The resonance element 25 is formed such that the open end 25A is positioned near the short-circuited end 24B of the resonance element 24 and the short-circuited end 25B is positioned near the open end 24A of the resonance element 24.

Accordingly, the resonance element 25 is formed such that the open end 25A is positioned near the bent part 12C of the power feeding line 12 and the short-circuited end 25B is positioned near the end part 12B of the power feeding line 12.

Among the resonance elements 21 through 25, electromagnetic field coupling is achieved between the resonance element 21 and the resonance element 22, electromagnetic field coupling is achieved between the resonance element 22 and the resonance element 23, electromagnetic field coupling is achieved between the resonance element 23 and the resonance element 24, and electromagnetic field coupling is achieved between the resonance element 24 and the resonance element 25. Accordingly, electromagnetic field coupling is achieved between adjacent resonance elements among the resonance elements 21 through 25.

As described above, the length of the resonance elements 21 through 25 is specified to be a half wavelength (λ/2) of the wavelength λ in the working frequency of the resonance elements 21 through 25. Therefore, when an electric wave of the working frequency is supplied via the power feeding line 11 or the power feeding line 12, resonance is generated using the working frequency as the center frequency.

As described above, electromagnetic field coupling is achieved between adjacent ones of the resonance elements 21 through 25, and therefore the resonance elements 21 through 25 have a predetermined bandwidth extending from the center frequency.

The bandwidth is determined according to the coupling coefficient of the resonance elements 21 through 25, and the coupling coefficient is determined according to the space between adjacent resonance elements.

Accordingly, the space between adjacent resonance elements is set so that the resonance elements 21 through 25 have a predetermined bandwidth based on a working frequency corresponding to a center frequency of resonance.

In the resonance element 25, one of the linear parts 25C (the linear part 25C on the right side as viewed in FIG. 1A) is parallel to the linear part 12E of the power feeding line 12 having an L shape. Accordingly, electromagnetic field coupling is achieved between the resonance element 25 and the power feeding line 12 in a state where the impedance is also matched.

As described above, in the antenna device 100 according to the first embodiment, electromagnetic field coupling is achieved between adjacent elements among the power feeding lines 11 and 12 and the resonance elements 21, 22, 23, 24, and 25.

The length of the resonance elements 21 through 25 is specified to be a half wavelength (λ/2) of the wavelength λ in the working frequency for reading identification information of RFID tags. Furthermore, the space between adjacent resonance elements is set so that the resonance elements 21 through 25 have a predetermined bandwidth based on the working frequency corresponding to a center frequency of resonance.

When an electric wave of the working frequency (953 MHz) is supplied to the resonance elements 21 through 25 via the power feeding line 11 or the power feeding line 12, resonance is generated based on the working frequency corresponding to the center frequency. Furthermore, the resonance elements 21 through 25 have a predetermined bandwidth determined by a coupling coefficient based on a center frequency corresponding to the center of the bandwidth. The bandwidth of the resonance elements 21 through 25 is described below with reference to simulation results.

Among the power feeding line 11, the resonance elements 21 through 25, and the power feeding line 12, it is possible to disregard any electromagnetic field coupling that occurs between two non-adjacent resonance elements by skipping past an adjacent resonance element, and therefore such electromagnetic field coupling is disregarded in this description.

FIGS. 2A and 2B illustrate an RFID tag for communicating with the antenna device 100 according to the first embodiment of the present invention. FIG. 2A is a plan view and FIG. 2B is illustrates an equivalent circuit.

As illustrated in FIG. 2A, an RFID tag 50 that communicates with the antenna device 100 according to the first embodiment includes a sheet 51 made of resin, a loop antenna part 52, a bypass line part 53, and an IC chip 54. The RFID tag 50 is a passive type RFID tag without a power source, which operates by power supplied from outside.

The sheet 51 is a resin film having a square shape in a planar view, with a width of w=16 mm, a length of l=16 mm, and a thickness of 0.1 mm.

The loop antenna part 52 is a rectangular loop formed on the surface of the sheet 51. The loop antenna part 52 has terminals 52A and 52B, which are connected to the IC chip 54. The loop antenna part 52 is not formed between the terminals 52A and 52B; the terminals 52A and 52B are connected by the IC chip 54. The loop antenna part 52 has a side A having a length of a=12 mm, a side B having a length of b=15 mm, and a width of w1=1 mm.

The above-described size of the loop antenna part 52 is an example selected in accordance with the size of the resonance elements 21 through 25 of the antenna device 100 according to the first embodiment; however, the size of the loop antenna part 52 is not so limited.

The bypass line part 53 is formed on the surface of the sheet 51 for bypassing a part of the loop of the loop antenna part 52. By bypassing a part of the loop of the loop antenna part 52, the inductance component is adjusted when a high frequency current passes through the loop antenna part 52. The inductance is determined by the position of the bypass line part 53 in the loop antenna part 52. In the RFID tag 50 illustrated in FIG. 2A, the bypass line part 53 is inserted in the loop antenna part 52 at a position parallel to the side A of the rectangular loop of the loop antenna part 52. Furthermore, the bypass line part 53 is inserted at a position corresponding to a length “c” within a length “b” of the side B.

For example, the loop antenna part 52 and the bypass line part 53 may be made of silver paste or a copper thin film. When silver paste is used, the loop antenna part 52 and the bypass line part 53 may be printed by an inkjet method with the use of a mixture of ink toner and silver particles. When a copper thin film is used, the loop antenna part 52 and the bypass line part 53 may be formed by wet etching a copper thin film formed on the surface of the sheet 51.

The IC chip 54 is disposed on the surface of the sheet 51. For example, the IC chip 54 includes a ROM (Read Only Memory) having a capacity of approximately 256 bytes. The IC chip 54 has two terminals 54A and 54B. The terminal 54A is connected to the terminal 52A of the loop antenna part 52 by soldering. The terminal 54B is connected to the terminal 52B of the loop antenna part 52 by soldering. As the IC chip 54 is inserted between the terminals 52A and 52B of the loop antenna part 52, the rectangular loop of the loop antenna part 52 is closed.

As indicated in the equivalent circuit of FIG. 2B, the loop antenna part 52 and the bypass line part 53 include a resistor R1 and an inductor L1. The IC chip 54 includes a resistor R2 and a capacitor C1. As described above, the terminal 52A of the loop antenna part 52 and the terminal 54A of the IC chip 54 are connected to each other. The terminal 52B of the loop antenna part 52 and the terminal 54B of the IC chip 54 are connected to each other.

The inductance of the inductor L1 illustrated in FIG. 2B is determined by the position of the bypass line part 53 in the loop antenna part 52 (see FIG. 2A).

The electrostatic capacity of the capacitor C1 illustrated in FIG. 2B is determined by the type of the IC chip 54 (mainly by the capacity of the memory such as the ROM).

Thus, the length “c” indicated in FIG. 2A is specified such that impedance matching is achieved between the circuits on the left and right illustrated in FIG. 2 and a resonance current is achieved in the loop antenna part 52, when the magnetic field passing through the loop antenna part 52 changes due to electric waves radiated by the antenna device 100.

FIG. 3 illustrates the reader/writer connected to the antenna device 100 according to the first embodiment of the present invention.

In FIG. 3, the end part 11A of the power feeding line 11 of the antenna device 100 according to the first embodiment is connected to a reader/writer (RW) 60 acting as a reading device. The RFID tag 50 is placed on the short-circuited end 24B of the resonance element 24. A PC (personal computer) 70 is connected to the reader/writer 60.

The reader/writer 60 is a reading device. The reader/writer 60 transmits reading signals from the antenna device 100 to the RFID tag 50 by superposing the reading signals on carrier waves. The reading signals are used for reading identification information from the RFID tag 50. Then, the reader/writer 60 demodulates the identification information returned from the RFID tag 50.

The PC 70 is a processing device for determining the presence of the RFID tag 50 based on the identification information read by the reader/writer 60, and executing a predetermined process based on the determination result. The process executed by the PC 70 is described in a sixth embodiment of the present invention.

When the reader/writer 60 transmits reading signals from the antenna device 100 by superposing the reading signals on carrier waves, the following occurs. That is, the magnetic field passing through the loop antenna part 52 in the RFID tag 50 changes, and a resonance current passes through the loop antenna part 52. Accordingly, sufficient power is supplied to the IC chip 54, so that the IC chip 54 is activated. At this time, electromagnetic field coupling is achieved between the RFID tag 50 and the resonator 20.

When power is supplied to the IC chip 54 via the loop antenna part 52, the IC chip 54 reads the identification information in the ROM, and transmits (returns) the identification information to the reader/writer 60 via the loop antenna part 52.

The identification information transmitted from the RFID tag 50 is received by the antenna device 100, and read at the reader/writer 60. The identification information read at the reader/writer 60 is input to the PC 70. Therefore, by executing a predetermined program of the PC 70, it is possible to determine the presence of the RFID tag 50.

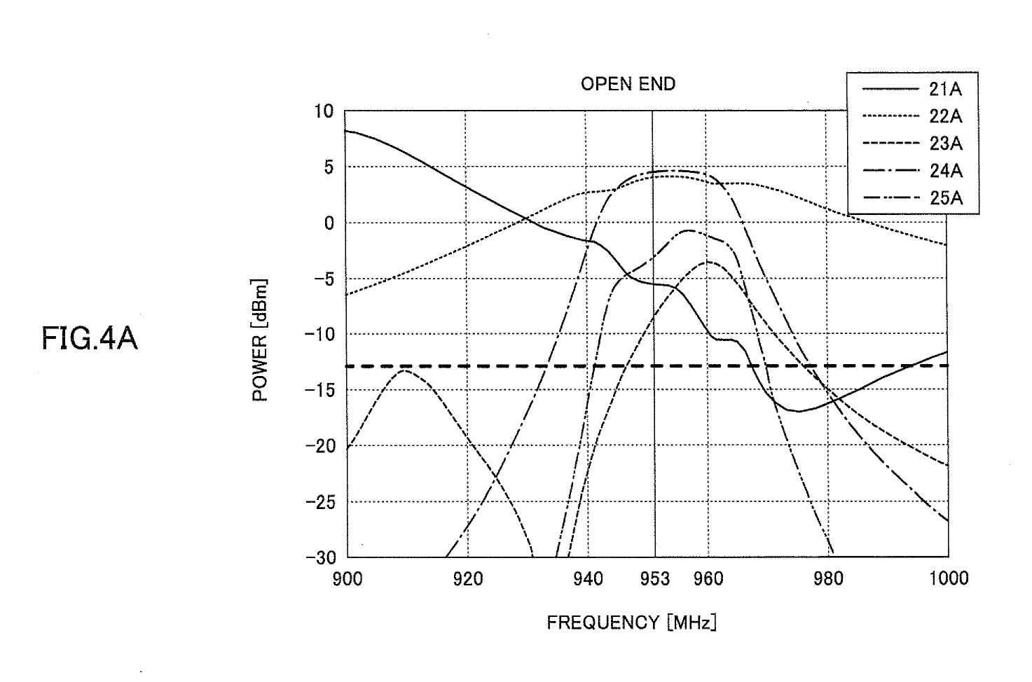

FIGS. 4A and 4B illustrate simulation results indicating the frequency properties of power generated at the RFID tag 50 placed on the resonator 20 of the antenna device 100. These simulation results indicate the frequency properties of power generated at the RFID tag 50, when the reader/writer 60 illustrated in FIG. 3 supplies power of 10 dBm to the antenna device 100. These simulation results are derived by an electromagnetic field simulator.

FIG. 4A indicates the frequency properties of power when the RFID tag 50 is placed at the open ends 21A through 25A. FIG. 4B indicates the frequency properties of power when the RFID tag 50 is placed at the short-circuited ends 21B through 25B.

Typically, power of approximately −12.5 dBm needs to be supplied to the RFID tag to cause the RFID tag to perform communications with the antenna device 100, and to cause the RFID tag to normally operate and transmit identification information. Accordingly, a dashed line is used to indicate the level of −12.5 dBm, which is the determination index.

As illustrated in FIG. 4A, outputs of greater than or equal to −12.5 dBm are acquired from all of the open ends 21A through 25A, ranging from approximately 940 MHz through approximately 970 MHz.

At the center frequency of 953 MHz, outputs of greater than or equal to approximately −8 dBm are acquired from all of the open ends 21A through 25A. Particularly high outputs of approximately 4 dBm are acquired from the open ends 22A and 24A.

With respect to the open ends 21A through 25A, it is not found that output from the open ends (for example, 24A or 25A) closer the end part 12A, which is a termination point, is lower than that from the open ends closer to the end part 11A. Accordingly, even at the open ends closer to the end part 12A, sufficient power is obtained for operating the IC chip 54 of the RFID tag 50.

Furthermore, as illustrated in FIG. 4B, output of greater than or equal to −12.5 dBm is obtained for all of the short-circuited ends 21B through 25B, between approximately 920 MHz through approximately 970 MHz.

At the center frequency 953 MHz, output of greater than or equal to approximately −6 dBm is obtained for all of the short-circuited ends 21B through 25B. Significantly high output of approximately 9 dBm and approximately 7 dBm is obtained at the short-circuited end 21B and the short-circuited end 22B, respectively.

The output from the short-circuited ends 23B, 24B, and 25B closer to the end part 12A, which is the termination point, is slightly lower than that from the short-circuited ends 21B and 22B that are closer to the power feeding lines 11 and 12, which is a power feeding point. However, significantly high output of greater than or equal to −5 dBm is obtained from the short-circuited ends 23B, 24B, and 25B, between approximately 940 MHz through approximately 960 MHz. Accordingly, even at the short-circuited ends closer to the end part 12A, sufficient power is obtained for operating the IC chip 54 of the RFID tag 50.

A description is given of a comparison example. An antenna element according to the comparison example has a micro-strip line bent in a meandering shape formed on the front surface 10A of the printed-circuit board 10, instead of the resonator 20, the power feeding line 11, and the power feeding line 12 included in the first embodiment of the present invention. A description is given of output properties when the RFID tag 50 is placed on such an antenna element according to the comparison example.

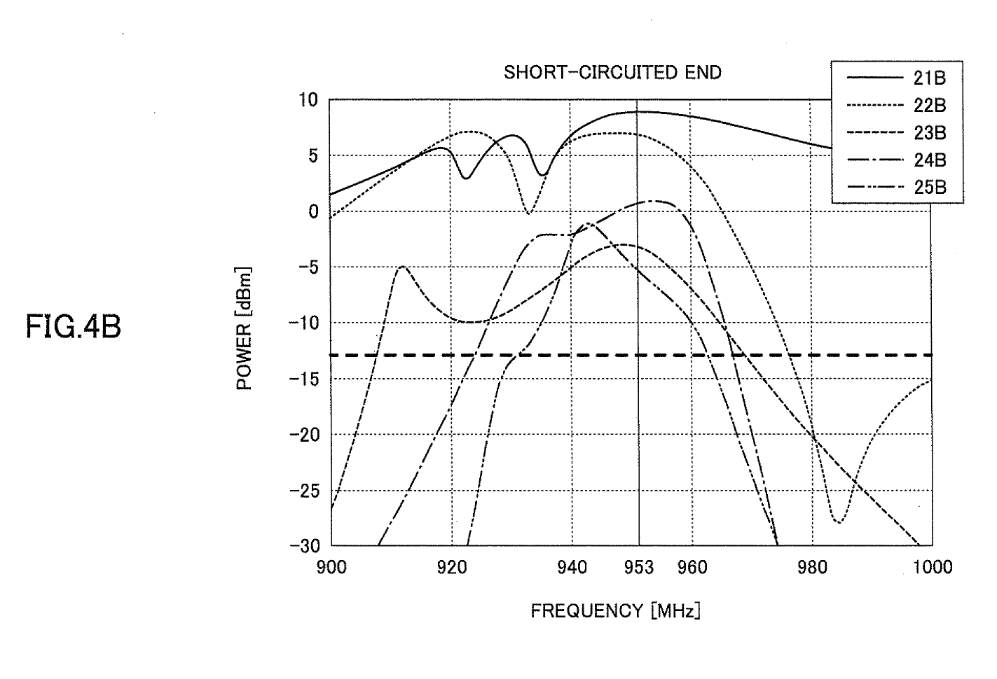

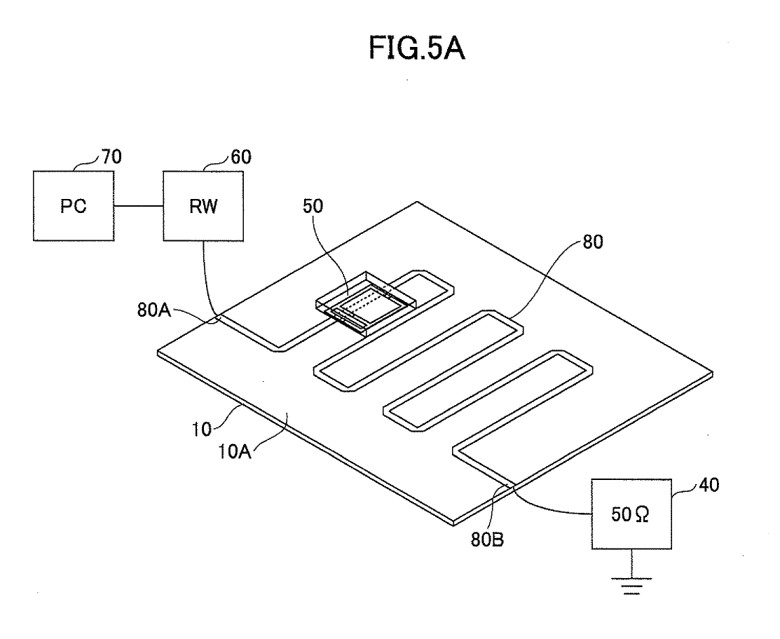

FIG. 5A illustrates the reader/writer 60 and the PC 70 connected to the antenna device according to the comparison example. FIG. 5B illustrates simulation results indicating frequency properties of power generated at the RFID tag 50 placed on the antenna device illustrated in FIG. 5A. Similar to the results illustrated in FIGS. 4A and 4B, the simulation results illustrated in FIG. 5B express the frequency properties of power generated at the RFID tag 50 when power of 10 dBm is supplied from the reader/writer 60 to the antenna device according to the comparison example. These simulation results are derived by an electromagnetic field simulator.

The antenna device according to the comparison example illustrated in FIG. 5A has a micro-strip line 80 having a meandering shape connected to an end part 80A (power feeding point) and an end part 80B (termination point), instead of providing the resonator 20, the power feeding line 11, and the power feeding line 12 between the end part 11A and the end part 12A as illustrated in FIGS. 1A and 3.

The micro-strip line 80 having a meandering shape may be formed by patterning copper foil by an etching process with the use of resist. The length and the number of meandering corners of the micro-strip line 80 between the end part 80A and the end part 80B may be any value according to the design.

As illustrated in FIG. 5A, among the meandering shapes of the micro-strip line 80, the RFID tag 50 is placed on a position that is closest to the end part 80A that is the power feeding point.

As illustrated in FIG. 5B, output of greater than or equal to −8 dBm is obtained between 900 MHz through 1000 MHz.

However, FIG. 5B illustrates the output at a position nearest to the end part 11A which is the power feeding point, among the meandering shapes of the micro-strip line 80. In the micro-strip line 80 that is a long transmission line with meandering shapes, the power is expected to decrease by approximately 7 dBm through 10 dBm near the end part 80B which is the termination point. Therefore, the RFID tag 50 is unlikely to operate properly near the end part 80B.

Furthermore, the simulation described above is conducted under the following conditions. That is, in order to read the RFID tag 50, the reader/writer 60 supplies the maximum amount of power (10 dBm) that may be used without the need of a Radio Transmitter License. However, in reality, there may be cases where communications are performed with the use of less power than 10 dBm. In this case also, the RFID tag 50 is unlikely to operate properly near the termination point.

Meanwhile, as indicated in FIGS. 4A and 4B, the antenna device 100 according to the first embodiment of the present invention is capable of achieving output that is higher than that of the antenna device according to the comparison example by approximately 7 dBm through 10 dBm.

In the antenna device 100 according to the first embodiment of the present invention, the length of the resonance elements 21 through 25 is specified to be the half wavelength of a wavelength in the working frequency. Therefore, resonance occurs in the respective resonance elements 21 through 25, the voltage value becomes maximum at the open ends 21A through 25A, and the current value becomes maximum at the short-circuited ends 21B through 25B.

Therefore, compared to the antenna device according to the comparison example, in the antenna device 100 according to the first embodiment of the present invention, the electric field is stronger at the open ends 21A through 25A and the magnetic field is stronger the short-circuited ends 21B through 25B. These are considered to be the reasons why the above high output is achieved in the antenna device 100 according to the first embodiment of the present invention.

As described above, high output is achieved at the open ends 21A through 25A and short-circuited ends 21B through 25B. Therefore, it is also considered that relatively high voltage values and current values may be achieved between the open ends 21A through 25A and short-circuited ends 21B through 25B.

As described above, the antenna device 100 according to the first embodiment of the present invention is capable of supplying sufficient power to the RFID tag 50 for performing communications in the entire area A (see FIG. 3) on the resonator 20. Therefore, the identification information may be read in the entire area A on the resonator 20.

When extraneous matter is adhering to the RFID tag 50 or to the surface of the resonator 20, the communication frequency may deviate from the working frequency (953 MHz). Even in such a situation, the antenna device 100 according to the first embodiment is capable of stably reading identification information from the RFID tag 50 because the antenna device 100 has a bandwidth of greater than or equal to approximately 20 MHz through 30 MHz, including a frequency as high as 953 MHz which is the center frequency of resonance.

When the antenna device 100 is put in practical use, even when the power supplied from the reader/writer drops below 10 dBm, there is enough margin with respect to −12.5 dBm (determination index), unlike the antenna device according to the comparison example. Therefore, even when the supplied power drops below 10 dBm, the antenna device 100 according to the first embodiment of the present invention is capable of reading identification information of the RFID tag 50 on the entire area on the resonator 20.

As described above, the antenna device 100 according to the first embodiment of the present invention is capable of reading identification information of the RFID tag 50 on the entire area on the resonator 20, and has an area used for communications that is larger than that of a conventional antenna device.

In the antenna device 100 according to the first embodiment of the present invention, the resonance elements 21 through 25 are positioned in such a manner that the open ends 21A through 25A and the short-circuited ends 21B through 25B are alternately arranged. Therefore, the distributions of the electric field and the magnetic field in the entire area on the resonator 20 are leveled out, and the communication status in the entire area is also leveled out.

Furthermore, as described above, the RFID tag 50 may be read in the entire area on the top surface of the resonator 20. Therefore, the antenna device 100 according to the first embodiment of the present invention is significantly more user friendly compared to a conventional antenna device in which the RFID tag is difficult to read near the termination point and between branch lines.

The antenna device 100 according to the first embodiment of the present invention is constituted by forming the power feeding lines 11 and 12 and the resonator 20 on the front surface 10A of the printed-circuit board 10, and forming the ground plane 30 on the back surface 10B. Therefore, the antenna device 100 according to the first embodiment may be manufactured at significantly lower cost than that of a conventional patch antenna device.

Furthermore, in the above description, the RFID tag 50 is directly placed on the resonator 20 of the antenna device 100. However, the antenna device 100 according to the first embodiment may read identification information even if the RFID tag 50 is spaced away from the surface of the resonator 20 by approximately 10 cm.

Furthermore, in the above description, the hairpin shaped resonance elements 21 through 25 included in the resonator 20 are positioned in such a manner that the open ends 21A through 25A and the short-circuited ends 21B through 25B are alternately arranged. However, the arrangement of the resonance elements 21 through 25 is not limited to that illustrated in FIG. 1A. The resonance elements 21 through 25 may be arranged in any manner as long as impedance matching is achieved between the power feeding line 11 and the resonance element 21, and also between the resonance element 25 and the power feeding line 12, and communications may be performed on the entire area on the resonator 20. For example, the resonance elements 21 through 25 may be formed such that the open ends 21A through 25A and the short-circuited ends 21B through 25B are arranged in opposite directions to those illustrated in FIG. 1A, or in random directions.

Furthermore, in the above example, the resonator 20 includes five resonance elements 21 through 25. However, the number of resonance elements is not limited to five. An optimum number of resonance elements may be provided so that an appropriate bandwidth is achieved in accordance with the purpose of the antenna device 100, as long as there is at least one resonance element.

Furthermore, in the above example, the power feeding lines 11 and 12 are micro-strip lines that are bent in a reversed L shape and an L shape, respectively. However, the power feeding lines 11 and 12 may have any shape and size as long as impedance matching is achieved between the resonance elements 21 and 25, respectively.

Furthermore, the power feeding lines 11 and 12 may be coplanar waveguides instead of micro-strip lines.

Furthermore, in the above description, the terminating resistor 40 is directly connected to the end part 12A of the power feeding line 12. However, the terminating resistor 40 may be connected to the end part 12A via a coaxial cable having an impedance of 50 Ω. Furthermore, a conventional patch antenna device may be connected to the end part 12A. When a patch antenna device having an impedance of 50 Ω is connected to the end part 12A, impedance matching is achieved between the end part 12A of the power feeding line 12 and another electronic device (patch antenna device).

Furthermore, in the above description, the working frequency of the reader/writer 60 is 953 MHz, which is the UHF band specified in Japan, and the resonance elements 21 through 25 have sizes in accordance with the wavelength in 953 MHz. However, when the reader/writer 60 is used in countries other than Japan, the resonance elements 21 through 25 may have sizes in accordance with the frequency of the country in which they are marketed. For example, the specified UHF band is 915 MHz in the United States and 868 MHz in Europe (EU). Therefore, in these countries, the length of the resonance elements 21 through 25 is to be the half wavelength of the wavelength λ in the corresponding frequencies.

Furthermore, in the above description, the working frequency of the reader/writer 60 is 953 MHz, which is the UHF band. However, when a microwave band (for example, 2.45 GHz) is used, the sizes of the resonance elements 21 through 25 are to be specified in accordance with the frequency of the microwave band.

Furthermore, in the above description, the IC chip 54 of the RFID tag 50 only reads the identification information; however, data received from the reader/writer 60 may be written into the IC chip 54.

Furthermore, in the above description, the reading device connected to the antenna device 100 is the reader/writer 60; however, the reading device connected to the antenna device 100 may not have a writing function as long as it has a reading function.

### Second Embodiment

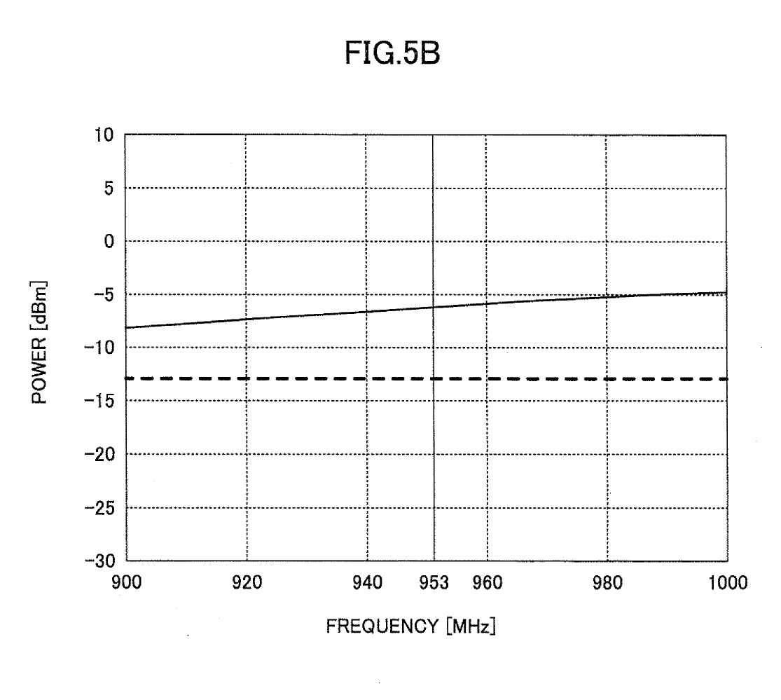

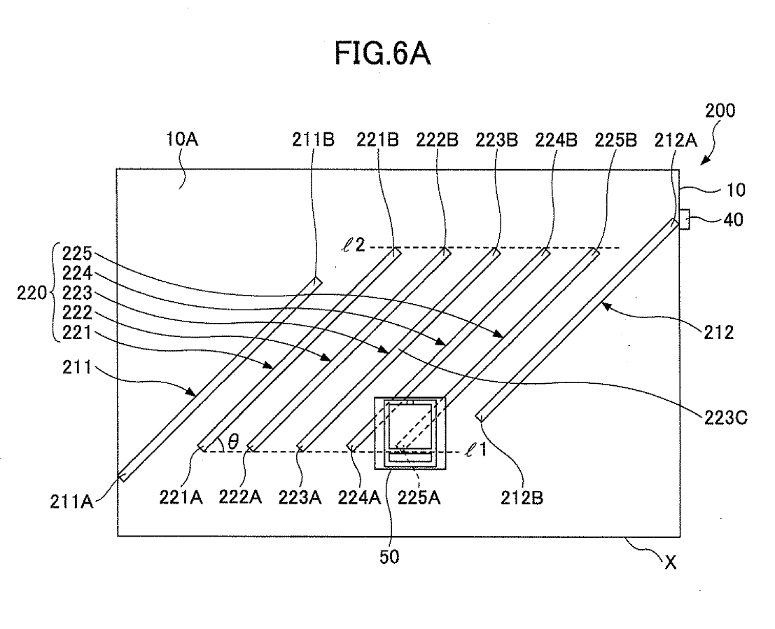

FIG. 6A is a plan view of an antenna device 200 according to a second embodiment of the present invention, and FIG. 6B illustrates the antenna device 200 connected to the reader/writer 60.

In the antenna device 200 according to the second embodiment, shapes of a resonator 220 and power feeding lines 211 and 212 formed on the front surface 10A of the printed-circuit board 10 are different from those of the resonator 20 and the power feeding lines 11 and 12 of the antenna device 100 according to the first embodiment. Other elements of the antenna device 200 according to the second embodiment are the same as those of the antenna device 100 according to the first embodiment, and therefore, corresponding elements are denoted by the same reference numerals and are not further described. The following descriptions are relevant to differences between the first and second embodiments.

As illustrated in FIG. 6A, the resonator 220 includes five linear resonance elements 221, 222, 223, 224, and 225.

The resonance elements 221 through 225 have the same shape. Each of the resonance elements 221 through 225 is a linear micro-strip line having free ends. The length of the resonance elements 221 through 225 is specified as substantially the half wavelength (λ/2) of a wavelength λ in the working frequency of the resonance elements 221 through 225.

In the second embodiment, the working frequency is 953 MHz.

The resonance elements 221 through 225 are formed on the front surface 10A of the printed-circuit board 10 such that the top surfaces are exposed. The length of these resonance elements 221 through 225 is determined in consideration of the thickness of the printed-circuit board 10, the dielectric constant (εr=4.4) of the printed-circuit board 10, and the dielectric constant of air (εs=1.00058).

For example, the half wavelength (λ/2) in the resonance elements 221 through 225 is specified as approximately 92.8 mm. The length of the resonance elements 221 through 225 may be derived by an electromagnetic field simulator.

The resonance elements 221 through 225 are equidistantly arranged parallel to each other on the front surface 10A of the printed-circuit board 10, in such a manner as to be obliquely arranged with respect to the four sides of the front surface 10A of the rectangular front surface 10A in a planar view.

End parts 221A through 225A of the resonance elements 221 through 225 are arranged along the same linear line l 1 parallel to a side X of the printed-circuit board 10. Furthermore, the other end parts 221B through 225B of the resonance elements 221 through 225 are arranged along the same linear line l 2 parallel to the side X of the printed-circuit board 10. An angle θ between each of the resonance elements 221 through 225 and the linear line l 1 is, for example, 45 degrees.

The resonance elements 221 through 225 are arranged such that a center point 223C in a longitudinal direction of the resonance element 223, which is positioned at the center of the five resonance elements 221 through 225, coincides with the center of the front surface 10A. In this case, the resonance elements 221 through 225 may be arranged symmetrically with respect to the center point 223C.

As illustrated in FIG. 6A, the power feeding lines 211 and 212 in the second embodiment are linear micro-strip lines having free ends.

The power feeding line 211 may have an optimum length in consideration of the space between the power feeding line 211 and the resonance element 221 so that impedance matching is achieved between the resonance element 221 that is adjacent to the power feeding line 211. In the example of FIG. 6A, the resonance elements 221 through 225 have the same length (λ/2).

Similarly, the power feeding line 212 may have an optimum length in consideration of the space between the power feeding line 212 and the resonance element 225 so that impedance matching is achieved between the resonance element 225 adjacent to the power feeding line 212. In the example of FIG. 6A, the resonance elements 221 through 225 have the same length (λ/2).

The power feeding line 211 is arranged adjacent to and in parallel with the resonance element 221 on the front surface 10A of the printed-circuit board 10.

The power feeding line 211 has an end part 211A corresponding to the power feeding point. The end part 211A is positioned on one of the edges of the printed-circuit board 10. The power feeding line 211 has the same length as the resonance elements 221 through 225, and therefore the other end part 211B of the power feeding line 211 is spaced apart from the linear line l 2.

The space between the power feeding line 211 and the resonance element 221 is adjusted such that impedance matching is achieved between the power feeding line 211 and the resonance element 221.

Electromagnetic field coupling is achieved between the power feeding line 211 and the resonance element 221 in a state where the impedance is also matched.

The above configuration is for achieving a substantially nonreflective state between the power feeding line 211 and the resonance element 221 so that the power loss is substantially zero when supplying power from the power feeding line 211 to the resonance element 221.

The space between the power feeding line 211 and the resonance element 221, and the length, width, and thickness of the power feeding line 211 are to be set so that impedance matching is achieved between the power feeding line 211 and the resonance element 221. The present invention is not limited to the values relevant to the space, length, width, and thickness specifically described above.

The power feeding line 212 is arranged adjacent to and in parallel with the resonance element 225 on the front surface 10A of the printed-circuit board 10.

The power feeding line 212 has an end part 212A corresponding to the termination point. The end part 212A is positioned on one of the edges of the printed-circuit board 10. The terminating resistor 40 is connected to the end part 212A.

The power feeding line 212 has the same length as the resonance elements 221 through 225, and therefore the other end part 212B of the power feeding line 212 is spaced apart from the linear line l 1.

The space between the power feeding line 212 and the resonance element 225 is adjusted such that impedance matching is achieved between the power feeding line 212 and the resonance element 225.

Electromagnetic field coupling is achieved between the power feeding line 212 and the resonance element 225 in a state where the impedance is also matched.

The above configuration is for achieving a substantially nonreflective state between the power feeding line 212 and the resonance element 225 so that the power loss is substantially zero when supplying power from the power feeding line 212 to the resonance element 225.

The space between the power feeding line 212 and the resonance element 225, and the length, width, and thickness of the power feeding line 212 are to be set so that impedance matching is achieved between the power feeding line 212 and the resonance element 225. The present invention is not limited to the values relevant to the space, length, width, and thickness described specifically above.

The impedance of the terminating resistor 40 is to match the input impedance of the power feeding line 212, the resonator 220, and the power feeding line 211 as viewed from the end part 212A in a state where the terminating resistor 40 is removed. The input impedance of the antenna device 200 according to the second embodiment of the present invention is 50 Ω, and therefore the impedance of the terminating resistor 40 is to be specified as 50 Ω.

Among the resonance elements 221 through 225, electromagnetic field coupling is achieved between the resonance element 221 and the resonance element 222, electromagnetic field coupling is achieved between the resonance element 222 and the resonance element 223, electromagnetic field coupling is achieved between the resonance element 223 and the resonance element 224, and electromagnetic field coupling is achieved between the resonance element 224 and the resonance element 225. Accordingly, electromagnetic field coupling is achieved between adjacent resonance elements among the resonance elements 221 through 225.

As described above, the length of the resonance elements 221 through 225 is specified to be a half wavelength (λ/2) of the working frequency of the resonance elements 221 through 225. Therefore, when an electric wave of the working frequency is supplied, resonance is generated using the working frequency as the center frequency.

As described above, electromagnetic field coupling is achieved between adjacent ones of the resonance elements 221 through 225, and therefore the resonance elements 221 through 225 have a predetermined bandwidth extending from a center frequency.

The bandwidth is determined according to the coupling coefficient of the resonance elements 221 through 225, and the coupling coefficient is determined according to the space between adjacent resonance elements.

Accordingly, the space between adjacent resonance elements is set so that the resonance elements 221 through 225 have a predetermined bandwidth based on a working frequency corresponding to a center frequency of resonance.

Electromagnetic field coupling is achieved between the resonance element 225 and the power feeding line 212 in a state where the impedance is also matched.

As described above, in the antenna device 200 according to the second embodiment, electromagnetic field coupling is achieved between adjacent elements among the power feeding lines 211 and 212 and the resonance elements 221, 222, 223, 224, and 225.

The length of the resonance elements 221 through 225 is specified to be a half wavelength (λ/2) of the wavelength λ in the working frequency for reading identification information of RFID tags. Furthermore, the space between adjacent resonance elements is set so that the resonance elements 221 through 225 have a predetermined bandwidth based on the working frequency corresponding to a center frequency of resonance.

When an electric wave of the working frequency (953 MHz) is supplied to the resonance elements 221 through 225 via the power feeding line 211 or the power feeding line 212, resonance is generated based on the working frequency corresponding to the center frequency. Furthermore, the resonance elements 221 through 225 have a predetermined bandwidth determined by a coupling coefficient based on a center frequency corresponding to the center of the bandwidth. This configuration is the same as the resonance elements 21 through 25 included in the resonator 20 according to the first embodiment.

In the antenna device 200 according to the second embodiment, the length of the resonance elements 221 through 225 is specified to be the half wavelength of a wavelength in the working frequency. Therefore, resonance occurs in the respective resonance elements 221 through 225, the voltage value becomes maximum at the end parts 221A through 225A and the end parts 221B through 225B, and the current value becomes maximum at the center portions of the resonance elements 221 through 225.

Therefore, the electric field is strong at the end parts 221A through 225A and the end parts 221B through 225B, and the magnetic field is strong at the center portions of the resonance elements 221 through 225.

As described above, similar to the antenna device 100 according to the first embodiment of the present invention, the antenna device 200 according to the second embodiment of the present invention is capable of reading identification information of the RFID tag 50 on the entire area on the resonator 20, and includes an area used for communications that is larger than that of a conventional antenna device.

Furthermore, as described above, in the antenna device 200 according to the second embodiment, the linear resonance elements 221 through 225 and the power feeding lines 211 and 212 are obliquely arranged with respect to the side X of the printed-circuit board 10, and therefore the width of the antenna device 200 is reduced.

Furthermore, as illustrated in FIG. 6A, the antenna device 200 according to the second embodiment is formed symmetrically with respect to the center point 223C, and therefore the positions of the power feeding line 211 and the power feeding line 212 may be interchanged. That is to say, the terminating resistor 40 may be connected to the end part 211A and the reader/writer 60 may be connected to the end part 212A.

Furthermore, the antenna device 200 according to the second embodiment includes five linear resonance elements 221 through 225; however, the number of resonance elements is not limited to five. For example, as long as there is at least one resonance element, an optimum number of resonance elements may be provided in order to attain a particular bandwidth needed for an intended purpose.

Furthermore, the antenna device 200 according to the second embodiment includes linear resonance elements 221 through 225. However, in addition to the linear resonance elements, the antenna device 200 may also include the hairpin shaped resonance elements used in the first embodiment. In this case, any number of resonance elements and any combination of resonance elements may be selected as long as impedance matching is achieved between adjacent resonance elements.

### Third Embodiment

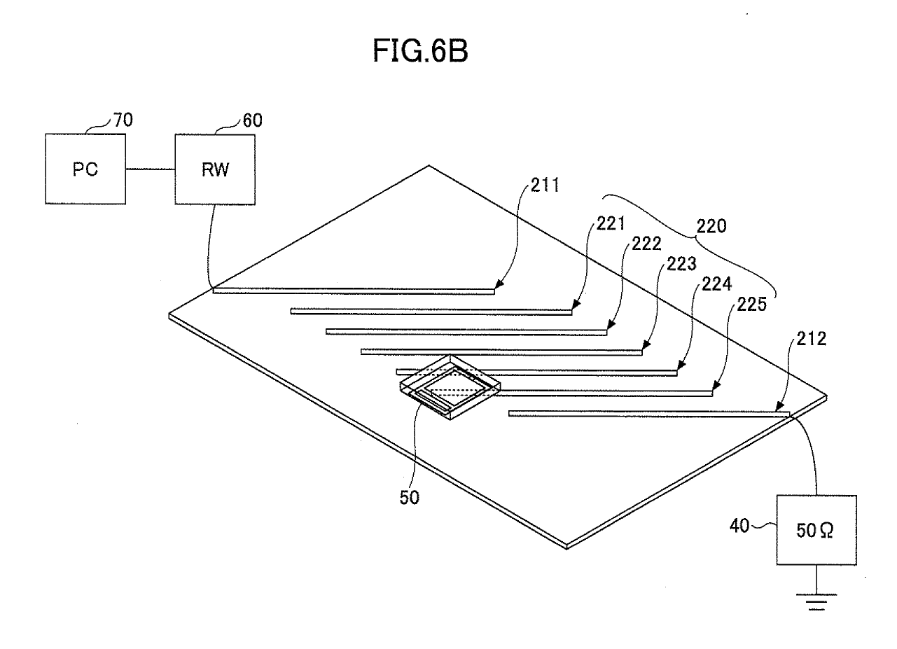

FIG. 7 is a perspective view of an antenna device 300 according to a third embodiment of the present invention.

The antenna device 300 according to the third embodiment is formed by connecting three antenna devices 100 according to the first embodiment in series. In the third embodiment, the three antenna devices 100 are denoted by reference numerals 100A, 100B, and 100C in order to be distinguished from one another. However, the antenna devices 100A, 100B, and 100C are the same as the antenna device 100 according to the first embodiment. Each of the antenna devices 100A, 100B, and 100C includes the resonator 20.

The end part 11A of the antenna device 100A is a power feeding point connected to a reader/writer. The end part 12A of the antenna device 100A is connected to the end part 11A of the antenna device 100B. The antenna device 100B receives power via the antenna device 100A.

The end part 12A of the antenna device 100B is connected to the end part 11A of the antenna device 100C. The terminating resistor 40 is connected to the end part 12A of the antenna device 100C. The antenna device 100C receives power via the antenna devices 100A and 100B.

The antenna devices 100A, 100B, and 100C may be connected by a connector having an impedance of 50 Ω, or may be connected by soldering so that impedance matching is achieved.

The antenna devices 100A, 100B, and 100C have the same impedance (50 Ω). Therefore, when the three antenna devices 100A, 100B, and 100C are connected in series, impedance matching is achieved.

As described with reference to FIGS. 4A and 4B, in the antenna device 100 according to the first embodiment, sufficient power for operating the RFID tag 50 is supplied in the entire area on the top surface of the resonator 20, regardless of whether the RFID tag 50 is placed near the power feeding point or the termination point.

Therefore, it is possible to read data from the RFID tag 50 on any of the resonators 20, even if the antenna devices 100A, 100B, and 100C are connected in series as illustrated in FIG. 7 and the RFID tag 50 is placed near the end part 12A of the antenna device 100C that is furthest from the end part 11A of the antenna device 100A.

Hence, the entire areas on the top surfaces of the resonators 20 of the three antenna devices 100A, 100B, and 100C may be used for performing communications with the RFID tag 50.

Accordingly, by connecting the antenna device 300 according to the third embodiment to a reader/writer, identification information of the RFID tag 50 may be read in the entire areas on the top surfaces of the resonators 20 of the three antenna devices 100A, 100B, and 100C

In the third embodiment, three antenna devices 100 according to the first embodiment are connected in series; however, the number of antenna devices 100 connected in series is not limited to three.

### Fourth Embodiment

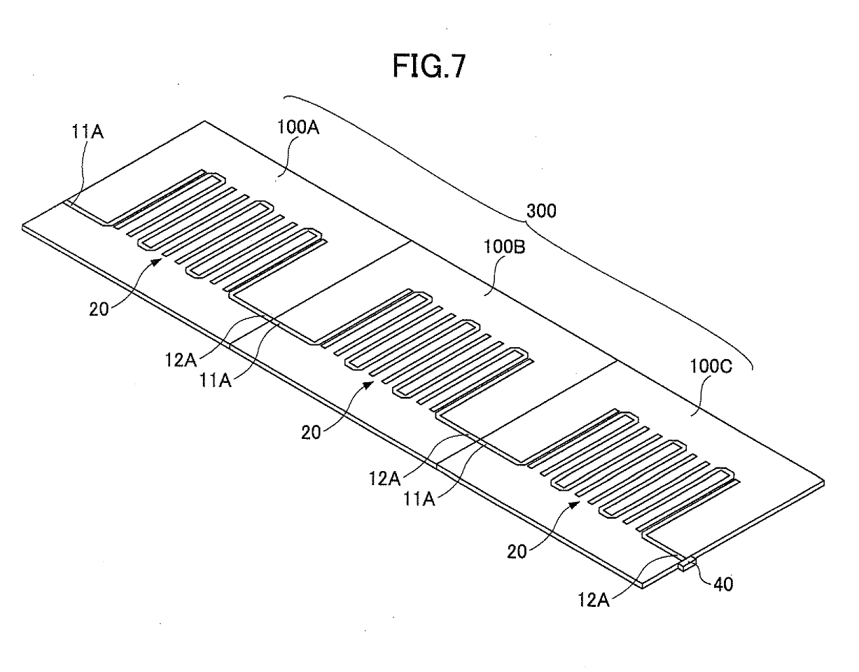

FIGS. 8A and 8B illustrate an antenna device 400 according to a fourth embodiment of the present invention; FIG. 8A is a plan view and FIG. 8B is a bottom view.

In the antenna device 400, two of the antenna devices 100 according to the first embodiment are arranged in parallel. As the antenna devices 100 are arranged in parallel, the shape of the power feeding line is different from that of the antenna device 100 according to the first embodiment. Furthermore, the widths of the power feeding line and the resonance elements of the antenna device 400 according to the fourth embodiment are different from those of the antenna device 100 according to the first embodiment, in order to achieve impedance matching in a state where the antenna devices are arranged in parallel.

As illustrated in FIG. 8A, the antenna device 400 includes a printed-circuit board 410, power feeding lines 411 and 412, and resonators 420A and 420B formed on a front surface 410A of the printed-circuit board 410. Micro-strip lines having the same width are used for forming the power feeding lines 411 and 412 and the resonators 420A and 420B.

For example, the printed-circuit board 410 is FR-4 (Flame Retardant Type 4; glass cloth base material epoxy resin substrate) having a dielectric constant of εr=4.4 and a dielectric tangent of tan δ=0.002. The printed-circuit board 410 has an area that is substantially two times as large as that of the front surface 10A of the printed-circuit board 10 of the first embodiment. As illustrated in FIG. 8B, a ground plane 430 is formed on the entire back surface of the printed-circuit board 410, similar to the printed-circuit board 10 of the first embodiment.

As illustrated in FIG. 8A, the power feeding line 411 is T-shaped, and includes an end part 411A, an end part 411B, a linear part 411C, an end part 411D, and a linear part 411E. The end part 411B and the end part 411D are arranged along the same line, with the linear part 411C and the linear part 411E positioned therebetween. The end part 411A extends from a point between the linear part 411C and the linear part 411E in such a manner as to form the base part of the T shape.

The power feeding line 412 has the same T shape as that of the power feeding line 411, and includes an end part 412A, an end part 412B, a linear part 412C, an end part 412D, and a linear part 412E. The end part 412B and the end part 412D are arranged along the same line, with the linear part 412C and the linear part 412E positioned therebetween. The end part 412A extends from a point between the linear part 412C and the linear part 412E in such a manner as to form the base part of the T shape.

The power feeding lines 411 and 412 are arranged so that the end part 411A and the end part 412A are aligned along a center line l 3 of the printed-circuit board 410, with the heads of the T shapes facing each other.

The resonators 420A and 420B each include resonance elements 21 through 25. The configurations of the resonance elements 21 through 25 in the resonators 420A and 420B are basically the same as those of the resonance elements 21 through 25 of the first embodiment, except that the widths are different for the purpose of achieving impedance matching with the parallel arrangement of the resonators 420A and 420B.

The resonators 420A and 420B are arranged symmetrically with respect to the center line l 3 of the printed-circuit board 410. More specifically, the resonance elements 21 through 25 included in the resonator 420A and the resonance elements 21 through 25 included in the resonator 420B are arranged symmetrically with respect to the center line l 3.

Among the resonance elements 21 through 25 included in each of the resonators 420A and 420B, electromagnetic field coupling is achieved between the resonance element 21 and the resonance element 22, electromagnetic field coupling is achieved between the resonance element 22 and the resonance element 23, electromagnetic field coupling is achieved between the resonance element 23 and the resonance element 24, and electromagnetic field coupling is achieved between the resonance element 24 and the resonance element 25. Accordingly, electromagnetic field coupling is achieved between adjacent resonance elements among the resonance elements 21 through 25.

Similar to the first embodiment, the length of the resonance elements 21 through 25 is a half wavelength (λ/2) of the working frequency of the resonance elements 21 through 25. Therefore, when an electric wave of the working frequency is supplied via the power feeding line 11 or the power feeding line 12, resonance is generated using the working frequency as the center frequency.

As described above, electromagnetic field coupling is achieved between the resonance elements 21 through 25, and therefore the resonance elements 21 through 25 have a predetermined bandwidth extending from the center frequency.

The bandwidth is determined according to the coupling coefficient of the resonance elements 21 through 25, and the coupling coefficient is determined according to the space between adjacent resonance elements.

Accordingly, the space between adjacent resonance elements is set so that the resonance elements 21 through 25 have a predetermined bandwidth based on a working frequency corresponding to a center frequency of resonance.

The linear part 411C of the power feeding line 411 is formed on the front surface 410A so that impedance matching is achieved between the power feeding line 411 and the resonance element 21 of the resonator 420A. Specifically, the space between the linear part 411C and the resonance element 21 of the resonator 420A, and the length, width and thickness of the linear part 411C are appropriately adjusted.

Similarly, the linear part 411E of the power feeding line 411 is formed on the front surface 410A so that impedance matching is achieved between the power feeding line 411 and the resonance element 21 of the resonator 420B. Specifically, the space between the linear part 411E and the resonance element 21 of the resonator 420B, and the length, width and thickness of the linear part 411E are appropriately adjusted.

Accordingly, electromagnetic field coupling is achieved between the power feeding line 411 and the resonance element 21 of the resonator 420A and also between the power feeding line 411 and the resonance element 21 of the resonator 420B in a state where the impedance is also matched.

The linear part 412C of the power feeding line 412 is formed on the front surface 410A so that impedance matching is achieved between the power feeding line 412 and the resonance element 25 of the resonator 420A. Specifically, the space between the linear part 412C and the resonance element 25 of the resonator 420A, and the length, width and thickness of the linear part 412C are appropriately adjusted.

Similarly, the linear part 412E of the power feeding line 412 is formed on the front surface 410A so that impedance matching is achieved between the power feeding line 412 and the resonance element 25 of the resonator 420B. Specifically, the space between the linear part 412E and the resonance element 25 of the resonator 420B, and the length, width and thickness of the linear part 412E are appropriately adjusted.

Accordingly, electromagnetic field coupling is achieved between the power feeding line 412 and the resonance element 25 of the resonator 420A and also between the power feeding line 412 and the resonance element 25 of the resonator 420B in a state where the impedance is also matched.

Accordingly, electromagnetic field coupling is achieved in parallel for the resonators 420A and 420B. Specifically, electromagnetic field coupling is achieved between the resonator 420A and both the power feeding lines 411 and 412. Similarly, electromagnetic field coupling is achieved between the resonator 420B and both the power feeding lines 411 and 412.

Impedance matching is to be achieved among the power feeding line 411, the resonator 420A, the resonator 420B, and the power feeding line 412, such that the input impedance is approximately 50 Ω at the power feeding line 411, the resonator 420A, the resonator 420B, and the power feeding line 412 as viewed from the end part 411A. The above configuration is for achieving a substantially nonreflective state among the power feeding line 411, the resonator 420A, the resonator 420B, and the power feeding line 412, so that the power loss is substantially zero when supplying power from the power feeding line 411 to the power feeding line 412 via the resonators 420A and 420B.

In the antenna device 400 according to the fourth embodiment, the power feeding line 411, the resonator 420A, the resonator 420B, and the power feeding line 412 are arranged in a bilaterally symmetric manner between the end part 411A and the end part 412A. Therefore, by achieving impedance matching as described above, input impedance of approximately 50 Ω is attained for the power feeding line 412, the resonator 420A, the resonator 420B, and the power feeding line 411, as viewed from the end part 412A.

Accordingly, electromagnetic field coupling is achieved between adjacent elements among the power feeding line 411, the resonance elements 21 through 25 included in the resonator 420A, the power feeding line 412, and the resonance elements 21 through 25 included in the resonator 420B, in a state where the impedance is also matched.

By connecting the antenna device 400 according to the fourth embodiment to a reader/writer, identification information may be read from the RFID tag 50 in a similar manner to that of the antenna device 100 according to the first embodiment.

As described with reference to FIGS. 4A and 4B, in the antenna device 100 according to the first embodiment, sufficient power for operating the RFID tag 50 is supplied in the entire area on the top surface of the resonator 20. Hence, even when two of the antenna devices 100 are connected in parallel as illustrated in FIG. 8A, the entire areas on the top surfaces of the resonators 420A and 420B may be used for performing communications with the RFID tag 50.

Accordingly, by connecting the antenna device 400 according to the fourth embodiment to a reader/writer, identification information of the RFID tag 50 may be read in the entire areas on the top surfaces of the resonators 420A and 420B.

In the fourth embodiment, two of the antenna devices 100 according to the first embodiment are arranged in parallel; however, the number of antenna devices 100 arranged in parallel is not limited to two.

### Fifth Embodiment

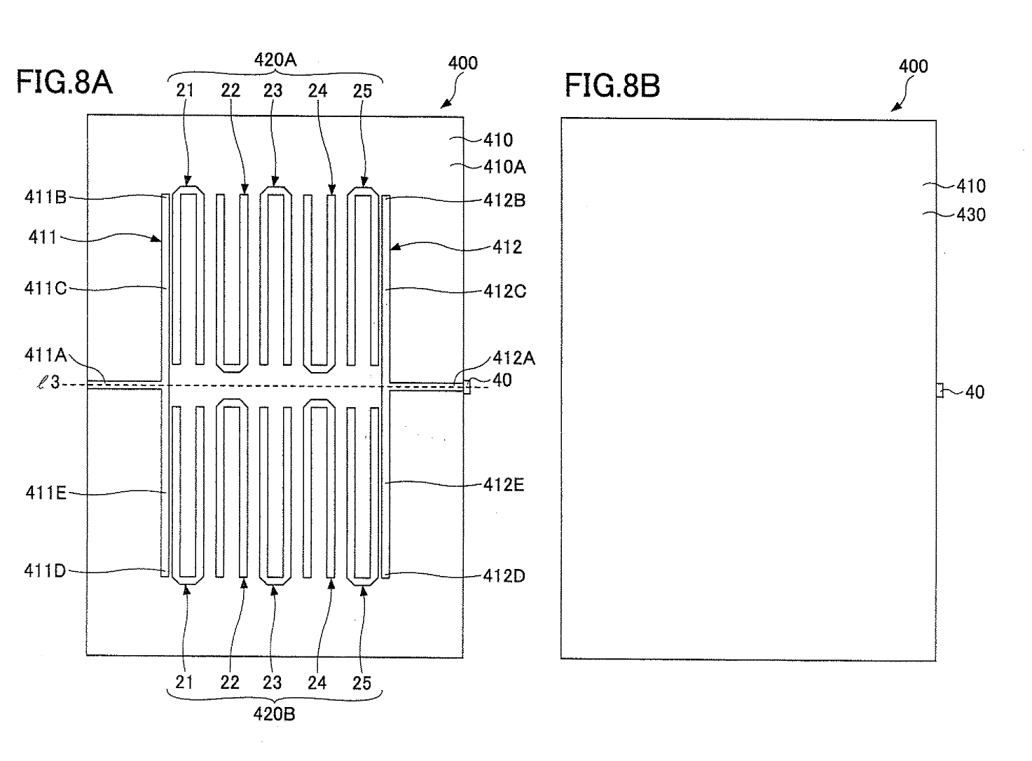

FIG. 9 is a perspective view of an antenna device 500 according to a fifth embodiment of the present invention.

The antenna device 500 according to the fifth embodiment is formed by connecting three antenna devices 400 according to the fourth embodiment in series.

In the fifth embodiment, the three antenna devices 400 are denoted by reference numerals 400A, 400B, and 400C in order to be distinguished from one another. However, the antenna devices 400A, 400B, and 400C are the same as the antenna device 400 according to the fourth embodiment.

The end part 411A of the antenna device 400A is a power feeding point connected to a reader/writer. The end part 412A of the antenna device 400A is connected to the end part 411A of the antenna device 400B. The antenna device 400B receives power via the antenna device 400A.

The end part 412A of the antenna device 400B is connected to the end part 411A of the antenna device 400C. The terminating resistor 40 is connected to the end part 412A of the antenna device 400C. The antenna device 400C receives power via the antenna devices 400A and 400B.

The antenna devices 400A, 400B, and 400C may be connected by a connector having an impedance of 50 Ω, or may be connected by soldering so that impedance matching is achieved.

The antenna devices 400A, 400B, and 400C have the same impedance (50 Ω). Therefore, when the three antenna devices 400A, 400B, and 400C are connected in series, impedance matching is achieved.

As described with reference to FIGS. 4A and 4B, in the antenna device 100 according to the first embodiment, sufficient power for operating the RFID tag 50 is supplied in the entire area on the top surface of the resonator 20, regardless of whether the RFID tag 50 is placed near the power feeding point or the termination point. The same applies to the antenna device 400 according to the fourth embodiment in which two of the antenna devices 100 according to the first embodiment are arranged in parallel.

Therefore, it is possible to read data from the RFID tag 50 on the resonators 420A and 420B, even if three of the antenna devices 400 according to the fourth embodiment are connected in series and the RFID tag 50 is placed near the end part 412A of the antenna device 400C that is furthest from the end part 411A of the antenna device 400A.

Hence, the entire areas on the top surfaces of the resonators 420A and 420B of the three antenna devices 400A, 400B, and 400C may be used for performing communications with the RFID tag 50.

Accordingly, by connecting the antenna device 500 according to the fifth embodiment to a reader/writer, identification information of the RFID tag 50 may be read in the same manner as that of the antenna device 400 according to the fourth embodiment.

In the fifth embodiment, three antenna devices 400 according to the fourth embodiment are connected in series; however, the number of antenna devices 400 connected in series is not limited to three.

### Sixth Embodiment

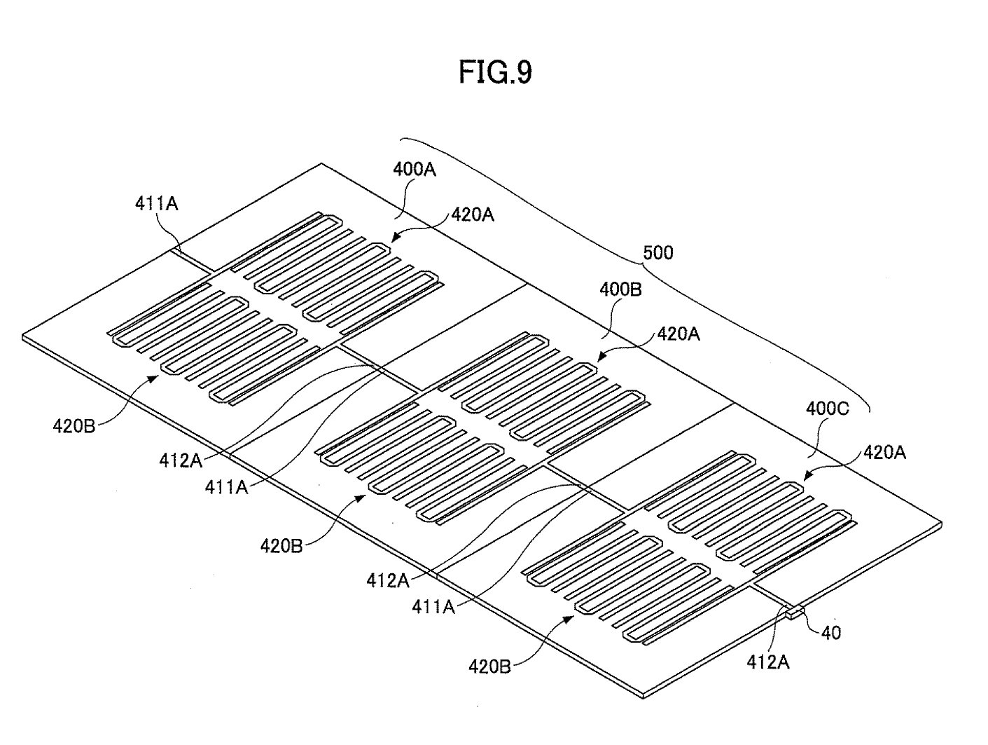

FIG. 10 illustrates a system 1000 according to a sixth embodiment of the present invention including an antenna device.

The system 1000 according to the sixth embodiment including an antenna device is for managing articles by using the antenna device 100 according to the first embodiment. In the sixth embodiment, reference is made to FIGS. 1A through 1C in describing the antenna device 100 according to the first embodiment.

The system 1000 according to the sixth embodiment includes the antenna device 100, the reader/writer 60, the PC 70, and a patch antenna device 90. The patch antenna device 90 is added as an example of an element for increasing the use application of the system 1000; however, such an expensive patch antenna device 90 may not be included in the system 1000.

The antenna device 100 and the reader/writer 60 are installed on a shelf 600A inside a cabinet 600. The cabinet 600 is made of metal for shielding electric waves that are radiated from the patch antenna device 90.

The patch antenna device 90 having a patch conductor is connected to the end part 12A of the antenna device 100 via a coaxial cable 91. That is to say, the antenna device 100 and the patch antenna device 90 are connected in series to the reader/writer 60. The impedance of the coaxial cable 91 is 50 Ω. The impedance of the patch antenna device 90 is set at 50 Ω, so that impedance matching is achieved between the patch antenna device 90 and the coaxial cable 91. Accordingly, the signals obtained by reading the RFID tag 50 are superposed on carrier waves in a substantially nonreflective state, and are input to the patch antenna device 90 via the antenna device 100 and the coaxial cable 91.

For example, the patch antenna device 90 has a communication range of approximately 3 m, and is disposed on a work surface 601A of a work table 601 located near the cabinet 600. The area of the patch antenna device 90 used for communications includes at least the entire work surface 601A.

The work surface 601A may be a square having an area of two meters square.

The system 1000 according to the sixth embodiment including an antenna device manages articles 610 (610A through 610E). RFID tags 50A through 50E are attached to the articles 610A through 610E, respectively. Therefore, the reader/writer 60 may read identification information of the RFID tags 50A through 50E of the articles 610A through 610E in the communication area of the antenna device 100 and the patch antenna device 90.

The articles 610 (610A through 610E) with the RFID tags 50 are usually stored on the antenna device 100 inside the cabinet 600.

However, FIG. 10 illustrates a state where four articles 610A, 610B, 610C, and 610D are placed directly on the antenna device 100, while the article 610E is placed on the work surface 601A of the work table 601. The work surface 601A is a communication area where the patch antenna device 90 reads identification information from the RFID tag 50.

Therefore, in the state illustrated in FIG. 10, the reader/writer 60 may read, via the antenna device 100, the identification information from the RFID tags 50A, 50B, 50C, and 50D attached to the articles 610A, 610B, 610C, and 610D, respectively. Furthermore, the reader/writer 60 may read, via the patch antenna device 90, identification information of the RFID tag 50E attached to the article 610E.

Accordingly, it is possible to identify whether the articles 610A through 610E are located inside the cabinet 600 or on the work surface 601A.

The system 1000 according to the sixth embodiment including the antenna device 100 manages the articles 610 (610A through 610E) as the PC 70 executes a process described below to operate the reader/writer 60.

Accordingly, the PC 70 includes an article management unit 70A that is a processing unit for managing articles. The article management unit 70A is implemented as a function of a CPU (Central Processing Unit) of the PC 70, and executes programs for performing processes relevant to managing articles.

The PC 70 includes programs executed by the article management unit 70A and a HDD (Hard Disk Drive) 70B for storing data used for executing the programs.

Furthermore, a monitor 70C is connected to the PC 70.

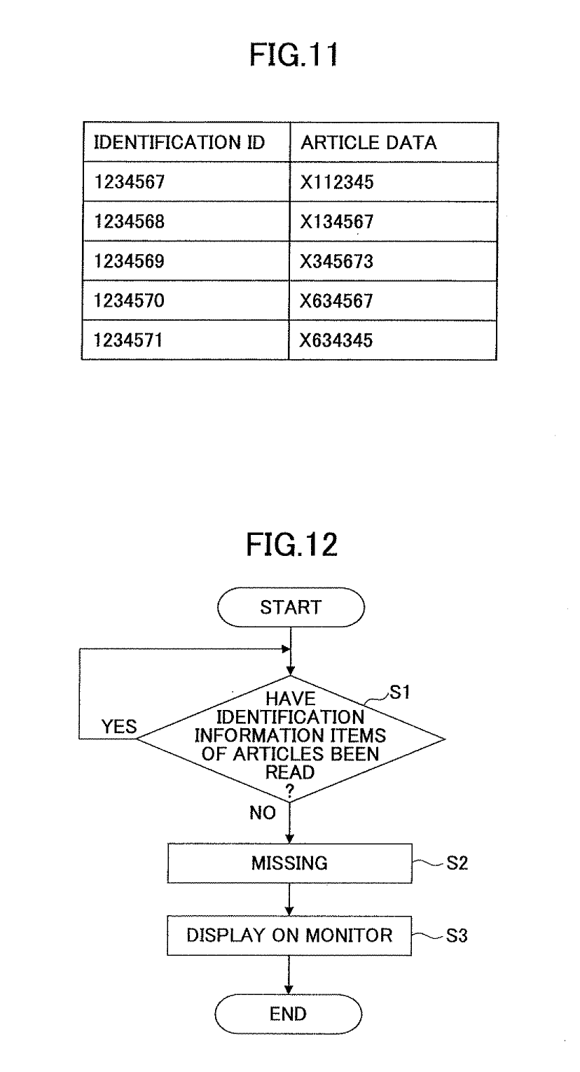

The article management unit 70A determines that an article among the articles 610A through 610E is missing when the identification information of any of the articles 610A through 610E cannot be read via the antenna device 100 or the patch antenna device 90. A process for making this determination is described below with reference to FIG. 12.

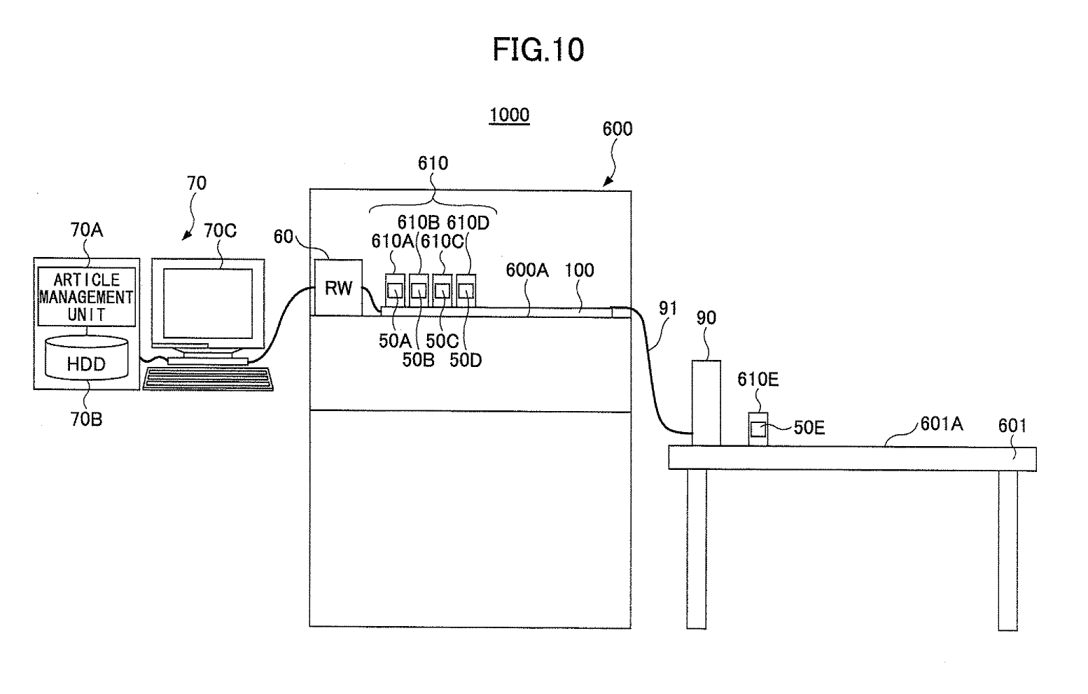

Next, before describing the process executed by the PC 70, a description is given of the relationship between the identification information (identification ID) of the RFID tags 50A through 50E and article data expressing the type of the articles 610A through 610E, with reference to FIG. 11.

FIG. 11 is a table indicating the relationship between identification ID and article data used in the system 1000 according to the sixth embodiment including an antenna device.

The identification ID is an identifier expressing identification information included in each of the RFID tags 50A through 50E. Different identifiers are assigned to the RFID tags 50A through 50E as identification ID.

Article data expresses the article name of each of the articles 610A through 610E.

The article data items expressing the articles 610A through 610E are associated with the identification ID items of the RFID tags 50A through 50E attached to the articles 610A through 610E, and are stored in the HDD 70B as a table as illustrated in FIG. 11.

FIG. 12 is a flowchart of an article management process performed by the system 1000 according to the sixth embodiment of the present invention including an antenna device. This process is executed by the article management unit 70A when the power is supplied for the reader/writer 60, the PC 70, and the patch antenna device 90.

All identification information items of the RFID tags 50A through 50E that are read by the antenna device 100 or the patch antenna device 90 are input into the reader/writer 60 at once. Therefore, the process illustrated in FIG. 12 is simultaneously executed for all of the articles 610A through 610E.

The article management unit 70A starts the process when power is supplied for the reader/writer 60, the PC 70, and the patch antenna device 90 (START).

The article management unit 70A determines whether identification information items of the RFID tags 50A through 50E attached to the respective articles 610A through 610E have been read by the antenna device 100 or the patch antenna device 90 (step S1).

When the article management unit 70A determines that the identification information of, for example, the RFID tag 50A has not been read by the antenna device 100 or the patch antenna device 90 in step S1, the article management unit 70A determines that the article with the corresponding RFID tag (whose identification information has not been read) is missing (step S2). For example, when the identification information of the RFID tag 50A of the article 610A has not been read by the antenna device 100 or the patch antenna device 90, it is considered that the article 610A is not present inside the cabinet 600 or on the work surface 601A.

Next, the article management unit 70A reads, from the HDD 70B, an article data item associated with the identification data item expressing the identification information of the missing article, and displays the name and the identification information of the missing article on the monitor 70C (step S3). This is to report that the article 610A is missing, with the use of the monitor 70C.

When the article management unit 70A completes step S3, the article management unit 70A ends the process (END).

When the article management unit 70A determines that identification information items of the RFID tags 50A through 50E attached to the articles 610A through 610E have been read in step S1, the article management unit 70A repeats the determination process of step S1. This determination process is repeatedly executed in order to manage the articles and detect whether there are any missing articles.

The sixth embodiment uses the antenna device 100 that is capable of reading the RFID tag in the entire area on the top surface of the resonator 20. Therefore, the sixth embodiment provides the system 1000 for managing articles which is capable of accurately determining whether the articles are present, regardless of where the articles with RFID tags are placed.

With this system 1000, RFID tags may be read in the entire area on the top surface of the resonator 20, which is thus more user friendly compared to conventional antenna devices in which the RFID tags are hard to read near the termination point.

Furthermore, the system 1000 uses the low-cost antenna device 100 that has a large communication area, and therefore a system capable of precisely determining whether articles are present is provided at low cost.

The system 1000 illustrated in FIG. 10 may be used for various purposes, such as managing articles that are prohibited from being removed (for example, toxic substances or dangerous drugs).

The system 1000 according to the sixth embodiment uses the antenna device 100 according to the first embodiment; however, any of the antenna devices according to the second through fifth embodiments according to the present invention may be used.

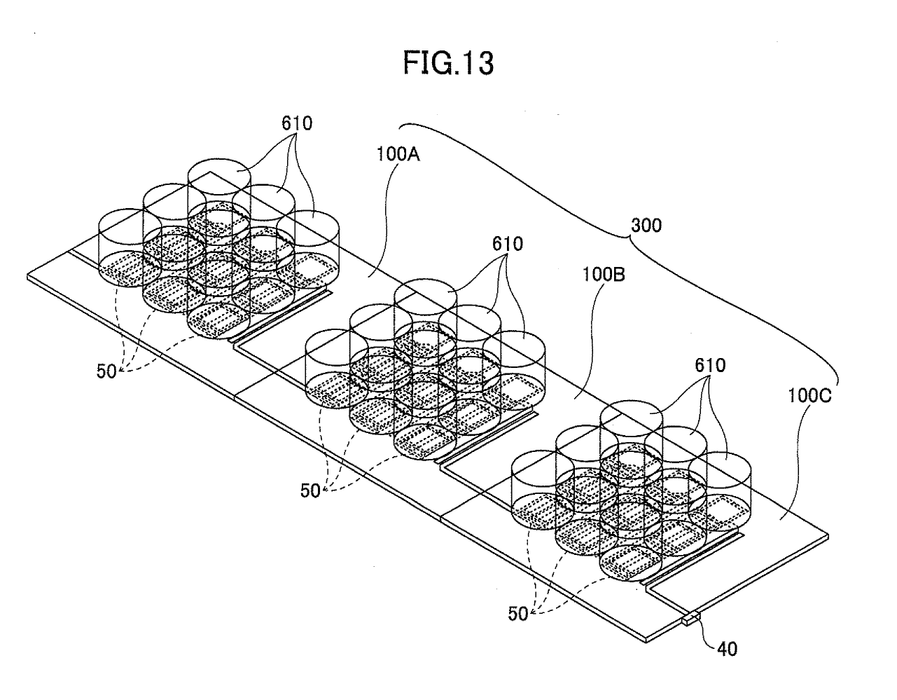

FIG. 13 is a perspective view of articles placed on an antenna device in the system 1000 according to the sixth embodiment including an antenna device. FIG. 13 illustrates multiple articles 610 placed on the antenna device 300 according to the third embodiment of the present invention. The articles 610 illustrated in FIG. 13 have RFID tags 50 attached on the bottom surfaces.

Even when multiple articles 610 are placed on the antenna device 300, the antenna devices 100A through 100C are capable of reading the RFID tags in the entire areas of the antenna devices 100A through 100C.

In a conventional antenna device, it has been difficult to read RFID tags particularly near the termination point, and therefore it has been impractical to connect plural antenna devices together. However, by using the antenna device 300 illustrated in FIG. 13, it is possible to read an RFID tag even at a location on the antenna device 300 that is furthest from the reader/writer 60.

According to one embodiment of the present invention, an antenna device and a system including an antenna device are provided, which include a large area used for communications, and which are suitable for short-range communications.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An antenna device for performing communications with an identification tag by being connected to a reading device that reads identification information of the identification tag, the antenna device comprising:
a first power feeding unit configured to receive power from the reading device;
a resonator that is electromagnetically coupled to the first power feeding unit, the resonator having a predetermined bandwidth including a working frequency of the reading device; and
a second power feeding unit that is electromagnetically coupled to the resonator, the second power feeding unit being terminated according to a predetermined resistance value.

2. The antenna device according to claim 1, wherein
the resonator includes a plurality of resonance elements having the predetermined bandwidth including the working frequency of the reading device.

3. The antenna device according to claim 2, wherein
the plural resonance elements are linear shaped and arranged parallel to each other.

4. The antenna device according to claim 3, further comprising:
a substrate on which the first power feeding unit, the resonator, and the second power feeding unit are formed, wherein
the plural resonance elements that are linear shaped are arranged obliquely with respect to a side of the substrate in a planar view.

5. The antenna device according to claim 2, wherein
the plural resonance elements are hairpin shaped and include two linear parts and a bent part connecting the two linear parts.

6. The antenna device according to claim 5, wherein
the plural resonance elements that are hairpin shaped include first ends and second ends, and
the plural resonance elements that are hairpin shaped are positioned in such a manner that the first ends and the second ends of mutually adjacent ones of the plural resonance elements are alternately arranged.

7. The antenna device according to claim 5, wherein
the plural resonance elements that are hairpin shaped are positioned in such a manner that positions of the two linear parts of mutually adjacent ones of the plural resonance elements are aligned in a longitudinal direction.

8. The antenna device according to claim 1, wherein
a plurality of the resonators is provided, and
the plural resonators are electromagnetically coupled parallel to the first power feeding unit and the second power feeding unit.

9. A system comprising:
the reading device; and
the antenna device according to claim 1.

10. The identification tag that is read by the antenna device according to claim 1.
